(19) United States
(12) Patent Application Publication
(10) Pub. No.: US 2026/0198590 A1
(43) Pub. Date: Jul. 16, 2026

(54) AEROSOL-GENERATING DEVICE AND AEROSOL-DELIVERY SYSTEM

(71) Applicant: Philip Morris Products S.A., Neuchatel (CH)

(72) Inventors: Rui Nuno Rodrigues Alves BATISTA, Morges (CH); Cristina FERRAZ RIGO, Pully (CH); Valerio OLIANA, Pully (CH)

(73) Assignee: Philip Morris Products S.A., Neuchatel (CH)

(21) Appl. No.: 19/134,509

(22) PCT Filed: Dec. 15, 2023
(86) PCT No.: PCT/EP2023/086134

§ 371 Date: May 30, 2025

(30) Foreign Application Priority Data
Dec. 15, 2022 (EP) 22213977.6

(51) Int. Cl. A24F 40/48; A24F 40/20; A24F 40/46; A24F 40/57; A24F 40/60; H05B 3/02

(52) U.S. Cl. CPC A24F 40/48; A24F 40/20; A24F 40/46; A24F 40/57; A24F 40/60; H05B 3/02

(57) ABSTRACT

An aerosol-generating device is provided, including: a housing and an electric heating arrangement, the housing extending along a longitudinal axis and including first and second housing parts releasably couplable to each other to define a mixing chamber therein, a coupling being such that first and second axial ends, respectively, of the first and second housing parts mate at an interface, the first housing part including a receiving region to receive an aerosol-generating article including an aerosol-forming substrate, the arrangement positioned within the housing to be in thermal communication with the receiving region, the first and second axial ends being shaped and configured such that, on coupling of the first and second housing parts, an airflow channel is defined at the interface by the mated first and second axial ends, the airflow channel extending through a wall of the housing into the mixing chamber to direct airflow into the mixing chamber.

The present disclosure relates to an aerosol-generating device and an aerosol-delivery system.

Aerosol-generating devices are known in which a heating element is used to heat an aerosol-forming substrate in order to generate an aerosol for inhalation by a user of the device. The heating element may be an electrically-powered heating element. More specifically, the heating element heats the aerosol-forming substrate sufficiently to generate a vapour containing volatile compounds evolved from the aerosol-forming substrate. In known aerosol-generating devices, in response to inhalation by a user of the device, air is drawn through the substrate and combines with the vapour evolved from the substrate. The airflow entrained with the vapour flows downstream to condense and form an aerosol, with the aerosol inhaled by the user. Such aerosol-generating devices have a resistance to draw, being the pressure drop of the air passing through the device to the mouth of the user. With the airflow flowing through the aerosol-forming substrate, the substrate is a significant contributor to the resistance to draw of the aerosol-generating device. In common with conventional cigarettes containing a rod of tobacco, the resistance to draw is a significant factor contributing to user satisfaction with the smoking experience. However, alternative aerosol-forming substrates are being developed in which an airflow is intended to flow over the substrate rather than through the substrate. Indeed, some of these alternative aerosol-forming substrates have a construction which would make airflow through the substrate impractical.

It is desirable to provide an aerosol-generating device adapted for channelling an airflow over a surface of a heated aerosol-forming substrate.

In accordance with a first embodiment of the present disclosure, there is provided an aerosol-generating device comprising a housing and an electric heating arrangement. The housing may extend along a longitudinal axis. The housing may comprise a first housing part and a second housing part releasably couplable to each other to define a mixing chamber therein. The coupling may be such that a first axial end of the first housing part mates with a second axial end of the second housing part at an interface. The first housing part may comprise a receiving region configured to receive an aerosol-generating article consisting of or comprising an aerosol-forming substrate. The electric heating arrangement may be positioned within the housing to be in thermal communication with the receiving region. The first and second axial ends may be shaped and configured such that, on coupling of the first housing part with the second housing part, at least one airflow channel is defined at the interface by the mated first and second axial ends. The at least one airflow channel extends through a wall of the housing into the mixing chamber to direct airflow into the mixing chamber in a direction transverse to the longitudinal axis, across the receiving region.

In this manner, the first and second housing parts are adapted to provide for channelling and directing of an airflow from outside of the device over the receiving region. So, when the aerosol-generating article is positioned in the receiving region, the airflow would be directed wholly or partly over a surface of the aerosol-generating article.

Preferably, the aerosol-generating article is the aerosol-forming substrate. For example, the aerosol-generating article may be in the form of one or a plurality of capsules of aerosol-forming substrate.

Preferably, the at least one airflow channel may be arranged to direct airflow into the mixing chamber partially along the longitudinal axis and away from the receiving region. By directing the airflow in this manner, a region of reduced pressure (a suction region) may be generated between the path taken by the airflow through the mixing chamber and the receiving region, thereby acting to draw vapour emanating from a surface of the aerosol-forming substrate away from the receiving region to become entrained with the airflow. More specifically, the at least one airflow channel may be configured to direct airflow into the mixing chamber so as to provide a reduction in static pressure between the receiving region and the airflow channel. In one embodiment, the at least one airflow channel may be inclined at an angle between zero degrees and 45 degrees to a plane normal to the longitudinal axis so as to direct airflow into the mixing chamber partially along the longitudinal axis and away from the receiving region.

Preferably, the at least one airflow channel may be arranged to direct airflow into the mixing chamber partially along the longitudinal axis and towards the receiving region. By directing the airflow in this manner, the airflow may directly impinge on a surface of the aerosol-forming substrate and become entrained with vapour emanating from the aerosol-forming substrate. Directing the airflow towards the surface of the aerosol-forming substrate may reduce the likelihood of overheating of the substrate. In one embodiment, the at least one airflow channel may be inclined at an angle between zero degrees and 45 degrees to a plane normal to the longitudinal axis so as to direct airflow into the mixing chamber partially along the longitudinal axis and towards the receiving region.

The at least one airflow channel may be a single airflow channel. However, advantageously, the at least one airflow channel may instead comprise a plurality of airflow channels. The plurality of airflow channels may be defined at the interface by the mated first and second axial ends. Different ones of the plurality of airflow channels may be arranged in opposition to each other so as to direct respective airflows towards each other within the mixing chamber. The arranging of airflow channels in opposition to each other facilitates collision and interference of different respective airflows with each other, thereby promoting turbulence and mixing of the airflows both with each other and with vapour emanating from a surface of the aerosol-forming substrate. More specifically, the plurality of airflow channels may comprise one or more opposed pairs of airflow channels, the airflow channels of each opposed pair arranged in opposition to each other so as to direct respective airflows towards each other within the mixing chamber.

The first axial end may comprise at least one first groove and the second axial end comprise at least one second groove. The first and second grooves may be arranged to align with each other on coupling of the first housing part with the second housing part to thereby define the at least one airflow channel.

Advantageously, the at least one airflow channel may comprise a plurality of airflow channels. The first axial end may comprise a first group of grooves and the second axial end comprise a second group of grooves. The first and second groups of grooves may be arranged such that, on coupling of the first housing part with the second housing part, each groove of the first group of grooves aligns with a corresponding groove of the second group of grooves to define a pair of aligned grooves, each pair of aligned grooves defining a corresponding one of the plurality of airflow channels.

However, in another example, one of the first axial end and the second axial end may comprise at least one groove, the at least one groove defining the at least one airflow channel on coupling of the first housing part with the second housing part, the other of the first and second axial ends being groove-free at least at the location of alignment with the groove. The entirety of the other of the first and second axial ends may be groove-free, leaving grooves defined in only one of the first and second axial ends. The at least one airflow channel may be aligned parallel to a plane normal to the longitudinal axis. In this manner, airflow may be efficiently drawn across the receiving region and across the aerosol-forming substrate.

Conveniently, the interface may be an annular interface. Advantageously, the first and second axial ends may be shaped and configured such that, on coupling of the first housing part with the second housing part, a plurality of the airflow channels is defined at the interface by the mated first and second ends, the plurality of airflow channels distributed around the annular interface. Preferably, the distribution of the plurality of airflow channels may be such that the spacing between adjacent ones of the plurality of airflow channels is uniform around the annular interface. A uniform distribution of the airflow channels may facilitate promoting homogenous mixing within the mixing chamber of the incoming airflow (received via the airflow channels) with vapour evolved from the aerosol-forming substrate. However, in an alternative embodiment, a non-uniform distribution may instead be employed for the spacing between adjacent ones of the plurality of airflow channels around the annular interface.

The aerosol-generating device may further comprise a thermal and magnetic shield, the thermal and magnetic shield and the electric heating arrangement successively aligned along the longitudinal axis within the housing. The shield may be formed from any one of a copper alloy (such as copper alloy 770), or silicon-based particle-filled compounds incorporating one or more of silver, silver-aluminium, silver-copper, silver-glass fibre, and nickel-graphite. The shield may be formed of multiple layers of different foils.

In one example, the electric heating arrangement may comprise a resistive heating element. The resistive heating element may take various forms. Advantageously, the resistive heating element may comprise a planar surface arranged transversely across the receiving region and configured to support the aerosol-generating article in the receiving region. In this manner, the heating element may both support and impart heat directly to an aerosol-generating article received in the receiving chamber. The surface arranged transversely across the receiving region may be a planar surface. Preferably, the resistive heating element may be disposed within the first housing part. The aerosol-generating device may further comprise a thermal and magnetic shield, the thermal and magnetic shield and the resistive heating element successively aligned along the longitudinal axis within the housing.

In another embodiment, the electric heating arrangement may comprise an inductor and a susceptor. The inductor may be provided in the form of an inductor coil. The inductor coil may comprise a flat spiral inductor coil. The inductor coil may have a tubular shape or a helical shape. Preferably, the inductor coil is both tubular and helical. Preferably, the tubular and helical coil has a non-circular cross section, when viewed in a direction perpendicular to the longitudinal length direction of the coil, i.e. in a direction perpendicular to the magnetic centre-axis of the coil. The susceptor may comprise a planar surface arranged transversely across the receiving region and configured to support the aerosol-generating article in the receiving region. The surface arranged transversely across the receiving region may be a planar surface. The aerosol-generating device may further comprise a thermal and magnetic shield, the thermal and magnetic shield, inductor and susceptor successively aligned along the longitudinal axis within the housing.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and Joule heating through induction of eddy currents in the susceptor, depending on the electrical and magnetic properties of the susceptor material. Suitable materials for the susceptor include graphite, molybdenum, silicon carbide, stainless steels, niobium, aluminium and other conductive materials. Advantageously, the susceptor may be formed of ferromagnetic material. Preferably, the susceptor may be formed of AISI 430 stainless steel.

The material of the susceptor may have a relative permeability between 1 and 40000, when measured at a suitable frequency and temperature; for example, when measured at frequencies up to 10 kHz at a temperature of 20 degrees Celsius. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the susceptor.

The aerosol-generating device may further comprise a power supply and control electronics, the control electronics configured to control a supply of energy from the power supply to the electric heating arrangement. Advantageously, coupling of the first housing part to the second housing part may define an electrically conductive pathway between the power supply and the electric heating arrangement, wherein uncoupling of the first housing part from the second housing part breaks the electrically conductive pathway. The electrically conductive pathway may define at least part of a circuit coupling the electric heating arrangement to the power supply.

Preferably, the first and second housing parts may be tubular, wherein an interior wall of the tubular first housing part defines a periphery of the receiving region, the receiving region configured to receive a disc-shaped aerosol-generating article. So, the tubular construction of the first housing part may facilitate in retaining the aerosol-generating article. Conveniently, a planar surface of the electric heating arrangement may define a base of the receiving region. The planar surface may form part of one of a resistive heating element or a susceptor of the electric heating arrangement.

Preferably, the second housing part may comprise a mouthpiece in communication with the mixing chamber. The provision of such a mouthpiece facilitates a user inhaling an aerosol from the mixing chamber, in which the aerosol is formed from vapour evolved from heating of the aerosol-forming substrate entrained with air received via the at least one airflow channel. The mouthpiece is preferably disposed at an opposite end of the second housing part to the interface.

The first and second housing parts may be coupled to each other by a mechanical interconnection. Preferably, the mechanical interconnection is configured such that the first and second housing parts are coupled to each other in a predetermined relative alignment. The predetermined relative alignment may preferably be an alignment which facilitates the formation of the at least one airflow channel; for example, where an airflow channel is defined by mating of a groove on the first axial end of the first housing part with a corresponding groove on the second axial end of the second housing part. By way of example, the first and second housing parts may be coupled to each other by one of a threaded connection and a bayonet connection.

The aerosol-generating device may further comprise an ejector assembly configured to urge the aerosol-generating article out from the receiving region of the first housing part. The provision of such an ejector assembly may facilitate the removal of the aerosol-generating article from the receiving region once the aerosol-forming substrate has been depleted.

Advantageously, the ejector assembly may comprise a support element for supporting the aerosol-generating article in the receiving region. The support element may be moveable within the first housing part away from the receiving region; for example, along the longitudinal axis. The support element may form part of the electric heating arrangement. By way of example, the support element may form part of one of a resistive heating element or a susceptor of the electric heating arrangement. Preferably, the ejector assembly may comprise one or more biasing elements configured to urge the support element out from the receiving region of the first housing part.

The ejector assembly may comprise an electromagnet assembly having a first state and a second state, in which the first state is an active state and the second state is an inactive state. The electromagnet assembly may be configured such that in the active state, the electromagnet assembly urges the aerosol-generating article out from the receiving region of the first housing part.

In another aspect of the present disclosure, there is provided an aerosol-delivery system comprising an aerosol-generating device according to any one of the variants described herein and an aerosol-generating article consisting of or comprising an aerosol-forming substrate. The aerosol-generating article may be arranged in the receiving region, the at least one airflow channel extending through the wall of the housing into the mixing chamber to direct airflow into the mixing chamber in a direction transverse to the longitudinal axis, across a surface of the aerosol-generating article.

As described in preceding paragraphs, preferably, the aerosol-generating article is the aerosol-forming substrate. For example, the aerosol-generating article may be in the form of one or a plurality of capsules of the aerosol-forming substrate.

The aerosol-generating article may comprise opposed planar surfaces connected by one or more peripheral edge surfaces, in which the opposed planar surfaces define a major portion of the total external surface area of the article relative to the one or more peripheral edge surfaces. The aerosol-generating article may be arranged in the receiving region such that that the opposed planar surfaces extend in a direction transverse to the longitudinal axis across the receiving region.

Preferably, the first and second housing parts may be tubular and the aerosol-generating article is disc-shaped, with an interior wall of the tubular first housing part defining a periphery of the receiving region. The receiving region may be configured to receive the disc-shaped aerosol-generating article such a peripheral edge surface of the aerosol-generating article locates adjacent the interior wall of the tubular first housing. In this manner, the aerosol-generating article is prevented from laterally moving side to side within the aerosol-generating device during use of the aerosol-delivery system.

By way of example, the aerosol-generating article may comprise one or more capsules of aerosol-forming substrate. The aerosol-generating article may comprise a plurality of capsules of the aerosol-forming substrate, the plurality of capsules arranged in the receiving region in a stacked relationship.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-forming substrate” refers to a substrate consisting of or comprising an aerosol-forming material that is capable of releasing volatile compounds upon heating to generate an aerosol.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers .

The invention is defined in the claims. However, below there is provided a non-exhaustive list of non-limiting examples. Any one or more of the features of these examples may be combined with any one or more features of another example, embodiment, or aspect described herein.
Example Ex1: An aerosol-generating device comprising a housing and an electric heating arrangement;
   the housing extending along a longitudinal axis, the housing comprising a first housing part and a second housing part releasably couplable to each other to define a mixing chamber therein, wherein the coupling is such that a first axial end of the first housing part mates with a second axial end of the second housing part at an interface;
the first housing part comprising a receiving region configured to receive an aerosol-generating article consisting of or comprising an aerosol-forming substrate;
the electric heating arrangement positioned within the housing to be in thermal communication with the receiving region;
the first and second axial ends shaped and configured such that, on coupling of the first housing part with the second housing part, at least one airflow channel is defined at the interface by the mated first and second axial ends, the at least one airflow channel extending through a wall of the housing into the mixing chamber to direct airflow into the mixing chamber in a direction transverse to the longitudinal axis, across the receiving region.
Example Ex2. An aerosol-generating device according to Ex1, wherein the at least one airflow channel is arranged to direct airflow into the mixing chamber partially along the longitudinal axis and away from the receiving region.
Example Ex 3: An aerosol-generating device according to Ex2, wherein the at least one airflow channel is configured to direct airflow into the mixing chamber so as to provide a reduction in static pressure between the receiving region and the airflow channel.
Example Ex4: An aerosol-generating device according to either one of Ex2 or Ex3, wherein the at least one airflow channel is inclined at an angle between zero degrees and 45 degrees to a plane normal to the longitudinal axis so as to direct airflow into the mixing chamber partially along the longitudinal axis and away from the receiving region.
Example Ex5: An aerosol-generating device according to Ex1, wherein the at least one airflow channel is arranged to direct airflow into the mixing chamber partially along the longitudinal axis and towards the receiving region.
Example Ex6: An aerosol-generating device according to Ex5, wherein the at least one airflow channel is inclined at an angle between zero degrees and 45 degrees to a plane normal to the longitudinal axis so as to direct airflow into the mixing chamber partially along the longitudinal axis and towards the receiving region.
Example Ex7: An aerosol-generating device according to any one of Ex1 to Ex6, wherein the at least one airflow channel comprises a plurality of airflow channels, the plurality of airflow channels defined at the interface by the mated first and second axial ends, different ones of the plurality of airflow channels arranged in opposition to each other so as to direct respective airflows towards each other within the mixing chamber.
Example Ex8: An aerosol-generating device according to Ex7, wherein the plurality of airflow channels comprise one or more opposed pairs of airflow channels, the airflow channels of each opposed pair arranged in opposition to each other so as to direct respective airflows towards each other within the mixing chamber.
Example Ex9: An aerosol-generating device according to any one of Ex1 to Ex8, wherein the first axial end comprises at least one first groove and the second axial end comprises at least one second groove, wherein the first and second grooves are arranged to align with each other on coupling of the first housing part with the second housing part to thereby define the at least one airflow channel.
Example Ex10: An aerosol-generating device according to any one of Ex1 to Ex9, wherein the at least one airflow channel comprises a plurality of airflow channels, wherein the first axial end comprises a first group of grooves and the second axial end comprises a second group of grooves, wherein the first and second groups of grooves are arranged such that, on coupling of the first housing part with the second housing part, each groove of the first group of grooves aligns with a corresponding groove of the second group of grooves to define a pair of aligned grooves, each pair of aligned grooves defining a corresponding one of the plurality of airflow channels.
Example Ex11: An aerosol-generating device according to any one of Ex1 to Ex8, wherein one of the first axial end and the second axial end comprises at least one groove, the at least one groove defining the at least one airflow channel on coupling of the first housing part with the second housing part, the other of the first and second axial ends being groove-free at least at the location of alignment with the groove.
Example Ex11a: An aerosol-generating device according to Ex11, in which the entirety of the other of the first and second axial ends is groove-free.
Example Ex12: An aerosol-generating device according to any one of Ex1 to Ex11a, wherein the at least one airflow channel is aligned parallel to a plane normal to the longitudinal axis.
Example Ex13: An aerosol-generating device according to any one of Ex1 to Ex12, wherein the interface is an annular interface.
Example Ex14: An aerosol-generating device according to Ex13, wherein the first and second axial ends are shaped and configured such that, on coupling of the first housing part with the second housing part, a plurality of the airflow channels is defined at the interface by the mated first and second ends, the plurality of airflow channels distributed around the annular interface.
Example Ex15: An aerosol-generating device according to Ex14, wherein the distribution of the plurality of airflow channels is such that the spacing between adjacent ones of the plurality of airflow channels is uniform around the annular interface.
Example Ex15a: An aerosol-generating device according to any one of Ex1 to Ex15, further comprising a thermal and magnetic shield, the thermal and magnetic shield and the electric heating arrangement successively aligned along the longitudinal axis within the housing.
Example Ex16: An aerosol-generating device according to any one of Ex1 to Ex15a, wherein the electric heating arrangement comprises a resistive heating element.
Example Ex17: An aerosol-generating device according to Ex16, wherein the resistive heating element comprises a surface arranged transversely across the receiving region and configured to support the aerosol-generating article in the receiving region.
Example Ex17a: An aerosol-generating device according to Ex17, in which the surface arranged transversely across the receiving region is a planar surface.
Example Ex18: An aerosol-generating device according to any one of Ex16 to Ex17a, wherein the resistive heating element is disposed within the first housing part.
Example Ex19: An aerosol-generating device according to any one of Ex16 to Ex18, further comprising a thermal and magnetic shield, the thermal and magnetic shield and the resistive heating element successively aligned along the longitudinal axis within the housing.
Example Ex20: An aerosol-generating device according to any one of Ex1 to Ex15a, wherein the electric heating arrangement comprises an inductor and a susceptor.
Example Ex21: An aerosol-generating device according to Ex20, wherein susceptor comprises a surface arranged transversely across the receiving region and configured to support the aerosol-generating article in the receiving region.
Example Ex21a: An aerosol-generating device according to Ex21, in which the surface arranged transversely across the receiving region is a planar surface.
Example Ex22: An aerosol-generating device according to any one of Ex20 to Ex21a, further comprising a thermal and magnetic shield, the thermal and magnetic shield, inductor and susceptor successively aligned along the longitudinal axis within the housing.
Example Ex23: An aerosol-generating device according to any one of Ex1 to Ex22, further comprising a power supply and control electronics, the control electronics configured to control a supply of energy from the power supply to the electric heating arrangement.
Example Ex24: An aerosol-generating device according to Ex23, wherein coupling of the first housing part to the second housing part defines an electrically conductive pathway between the power supply and the electric heating arrangement, wherein uncoupling of the first housing part from the second housing part breaks the electrically conductive pathway.
Example Ex24a: An aerosol-generating device according to Ex24, in which the electrically conductive pathway defines at least part of a circuit coupling the electric heating arrangement to the power supply.
Example Ex25: An aerosol-generating device according to any one of Ex1 to Ex24a, wherein the first and second housing parts are tubular, wherein an interior wall of the tubular first housing part defines a periphery of the receiving region, the receiving region configured to receive a disc-shaped aerosol-generating article.
Example Ex26: An aerosol-generating device according to Ex25, wherein a planar surface of the electric heating arrangement defines a base of the receiving region.
Example Ex27: An aerosol-generating device according to Ex26, wherein the planar surface forms part of one of a resistive heating element or a susceptor of the electric heating arrangement.
Example Ex28: An aerosol-generating device according to any one of Ex1 to Ex27, wherein the second housing part comprises a mouthpiece in communication with the mixing chamber.
Example Ex29: An aerosol-generating device according to Ex28, wherein the mouthpiece is disposed at an opposite end of the second housing part to the interface.
Example Ex30: An aerosol-generating device according to any one of Ex1 to Ex29, wherein the first and second housing parts are coupled to each other by a mechanical interconnection.
Example Ex30a: An aerosol-generating device according to Ex30, wherein the mechanical interconnection is configured such that the first and second housing parts are coupled to each other in a predetermined relative alignment.
Example Ex30b: An aerosol-generating device according to Ex30b, wherein the predetermined relative alignment is an alignment which facilitates the formation of the at least one airflow channel.
Example Ex30c: An aerosol-generating device according to any one of Ex30 to Ex30b, wherein the first and second housing parts are coupled to each other by one of a threaded connection and a bayonet connection.
Example Ex31: An aerosol-generating device according to any one of Ex1 to Ex30c, further comprising an ejector assembly configured to urge the aerosol-generating article out from the receiving region of the first housing part.
Example Ex32: An aerosol-generating device according to Ex31, wherein the ejector assembly comprises a support element for supporting the aerosol-generating article in the receiving region, the support element moveable within the first housing part away from the receiving region.
Example Ex33: An aerosol-generating device according to Ex32, wherein the support element forms part of the electric heating arrangement.
Example Ex34: An aerosol-generating device according to Ex33, wherein the support element forms part of one of a resistive heating element or a susceptor of the electric heating arrangement.
Example Ex35: An aerosol-generating device according to any one of Ex32 to Ex34, wherein the ejector assembly comprises one or more biasing elements configured to urge the support element out from the receiving region of the first housing part.
Example Ex36: An aerosol-generating device according to any one of Ex31 to Ex35, wherein the ejector assembly comprises an electromagnet assembly having a first state and a second state, in which the first state is an active state and the second state is an inactive state.
Example Ex37: An aerosol-generating device according to Ex36, wherein the electromagnet assembly is configured such that in the active state, the electromagnet assembly urges the aerosol-generating article out from the receiving region of the first housing part.
Example Ex38: An aerosol-delivery system comprising an aerosol-generating device according to any one of Ex1 to Ex37, and an aerosol-generating article consisting of or comprising an aerosol-forming substrate, the aerosol-generating article arranged in the receiving region, the at least one airflow channel extending through the wall of the housing into the mixing chamber to direct airflow into the mixing chamber in a direction transverse to the longitudinal axis, across a surface of the aerosol-generating article.
Example Ex39: An aerosol-delivery system according to Ex38, wherein the aerosol-generating article comprises opposed planar surfaces connected by one or more peripheral edge surfaces, in which the opposed planar surfaces define a major portion of the total external surface area of the article relative to the one or more peripheral edge surfaces.
Example Ex40: An aerosol-delivery system according to Ex39, wherein the aerosol-generating article is arranged in the receiving region such that that the opposed planar surfaces extend in a direction transverse to the longitudinal axis across the receiving region.
Example Ex41: An aerosol-delivery system according to any one of Ex38 to Ex40, wherein the first and second housing parts are tubular and the aerosol-generating article is disc-shaped, wherein an interior wall of the tubular first housing part defines a periphery of the receiving region.
Example Ex42: An aerosol-delivery system according to Ex41, wherein the receiving region is configured to receive the disc-shaped aerosol-generating article such a peripheral edge surface of the aerosol-generating article locates adjacent the interior wall of the tubular first housing.
Example Ex43: An aerosol-delivery system according to any one of Ex38 to Ex42, wherein the aerosol-generating article comprises one or more capsules of aerosol-forming substrate.
Example Ex44: An aerosol-delivery system according to Ex43, in which the aerosol-generating article comprises a plurality of capsules of the aerosol-forming substrate, the plurality of capsules arranged in the receiving region in a stacked relationship.

Examples will now be further described with reference to the figures in which:

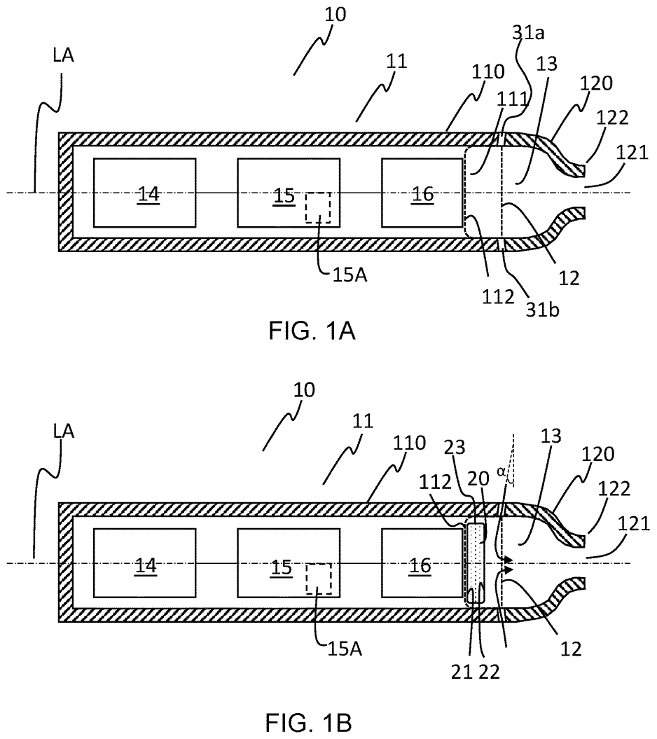

FIG. 1A shows a schematic illustration of a first embodiment of an aerosol-generating device according to the present disclosure.

FIG. 1B shows a schematic illustration of an aerosol-delivery system formed by the combination of the aerosol-generating device of FIG. 1A and an aerosol-generating article consisting of a capsule of an aerosol-forming substrate positioned in a receiving region of the aerosol-generating device.

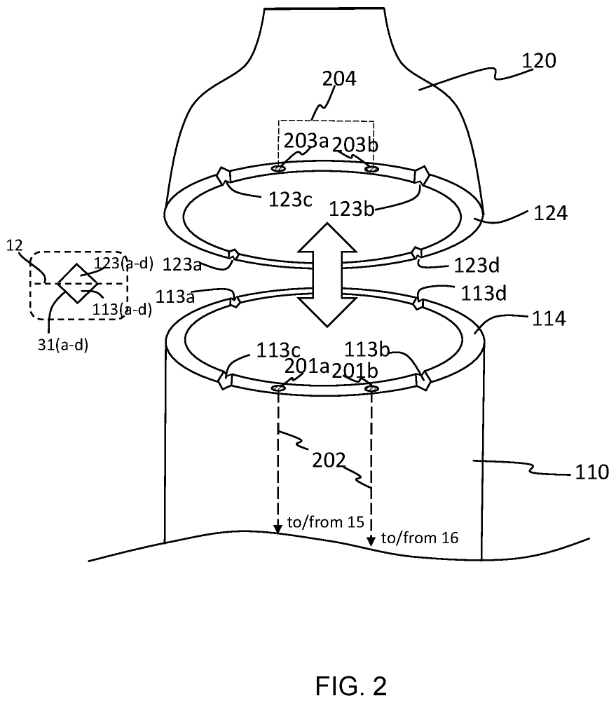

FIG. 2 shows a schematic perspective illustration of first and second housing parts of the aerosol-generating device of FIG. 1A.

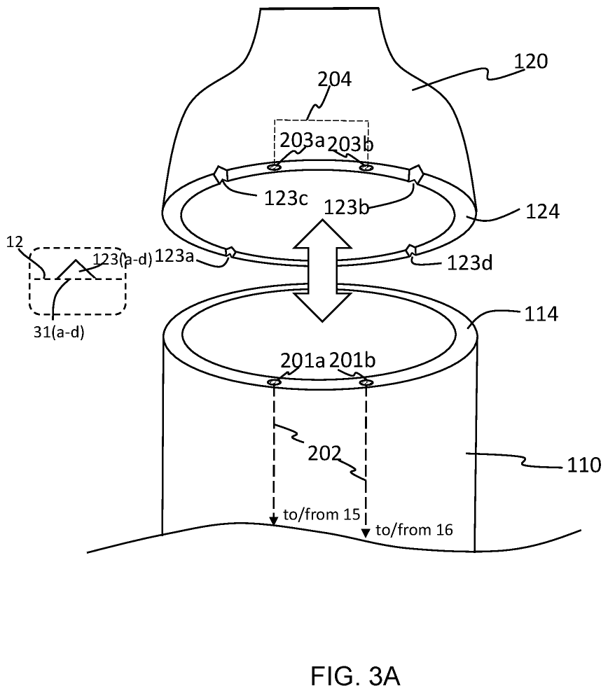

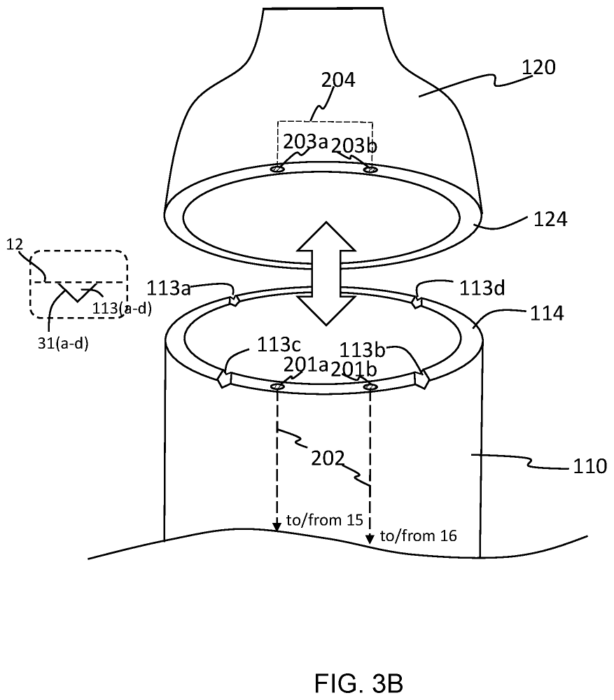

FIG. 3A shows a schematic perspective illustration of first and second housing parts of a second embodiment of the aerosol-generating device.

FIG. 3B shows a schematic perspective illustration of first and second housing parts of a third embodiment of the aerosol-generating device.

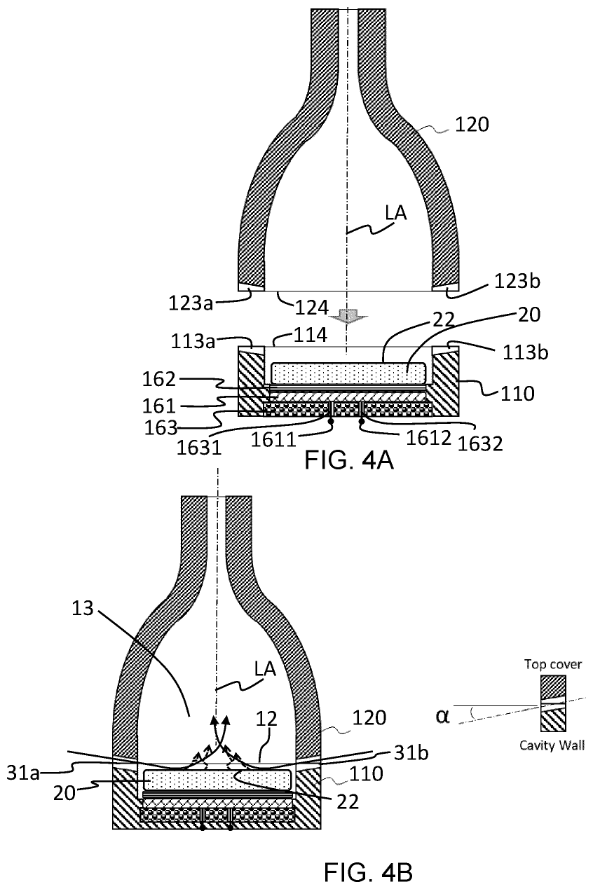

FIGS. 4A and 4B show two schematic cross-sectional illustrations of the first and second housing parts of the aerosol-generating device of FIGS. 1A and 1B and illustrates the alignment of a pair of airflow channels defined by coupling of the first and second housing parts with each other in a predetermined relative alignment.

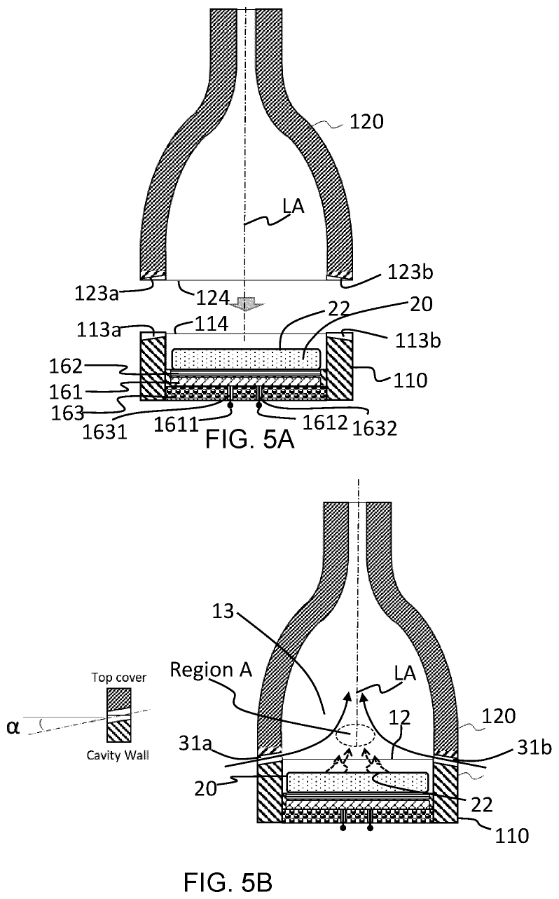

FIGS. 5A and 5B show two schematic cross-sectional illustrations of a variation to the first and second housing parts of the aerosol-generating device of FIGS. 1A and 1B and illustrates an alternative alignment of a pair of airflow channels defined by coupling of the first and second housing parts with each other in a predetermined relative alignment.

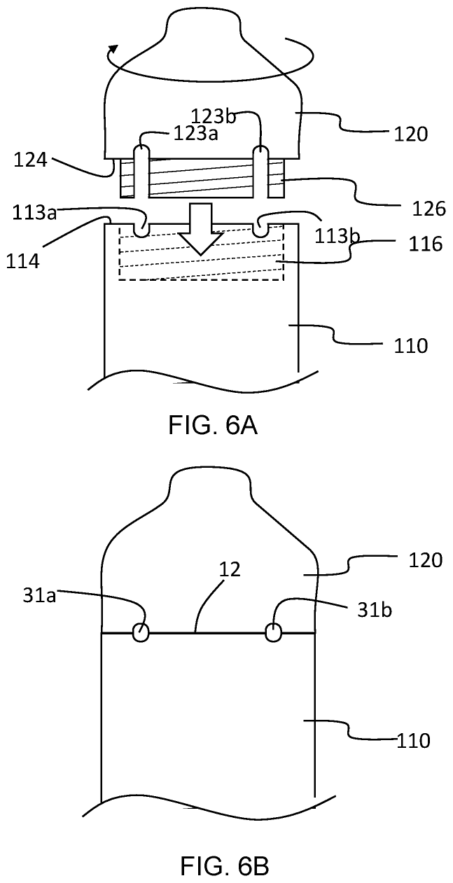

FIGS. 6A and 6B show a side elevation view of first and second housing parts of the aerosol-generating device of FIGS. 1A and 1B, illustrating the use of a threaded connection to couple the first and second housing parts together to form airflow channels at the interface of the first and second housing parts.

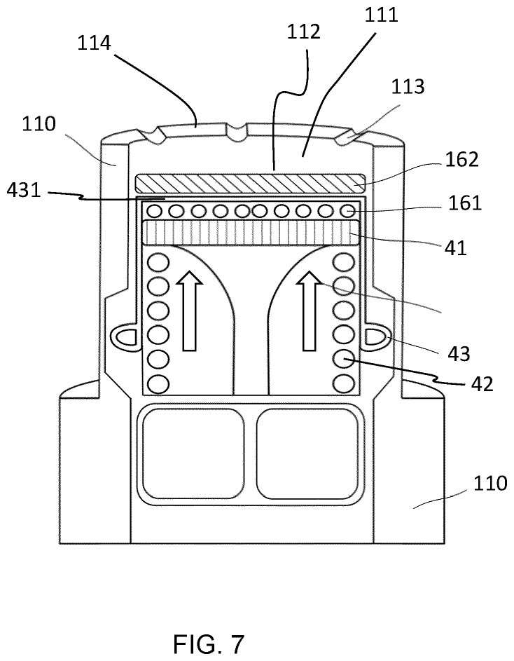

FIG. 7 shows a schematic cross-section of the first housing part of an embodiment of the aerosol-generating device provided with an ejector assembly.

FIG. 1A shows an aerosol-generating device 10. The device 10 has an elongate housing 11 extending along a longitudinal axis LA. The housing 11 has a first housing part 110 and a second housing part 120 which are releasably couplable to each other at an annular interface 12 to define a mixing chamber 13 therein. The first housing part defines a main body of the aerosol-generating device 10 and contains a power source 14, a controller 15 and an electric heating arrangement 16. A cup-shaped blind cavity 111 is located at one end of the first housing part 110; more specifically, the cup-shaped blind cavity 111 is located in close proximity to the interface 12 between the first and second housing parts 110, 120. As shown in FIG. 1B, the blind cavity 111 defines a receiving region for containing an aerosol-generating article 20. For the embodiment of FIG. 1B, the aerosol-generating article 20 is the form of a cylindrical capsule of aerosol-forming substrate. The capsule 20 of aerosol-forming substrate has two opposed planar surfaces 21, 22 joined by an annular peripheral surface 23. The area of each of the opposed planar surfaces 21, 22 is greater in magnitude than that of the annular peripheral surface 23. The capsule 20 is seated on a base 112 of the receiving region 111, with both of the opposed planar surfaces 21, 22 of the capsule 20 aligned perpendicular to the longitudinal axis LA. As will be described in subsequent paragraphs, in another exemplary embodiment the aerosol-generating article may instead take the form of a stack of capsules of aerosol-forming substrate. Different capsules of the stack of aerosol-forming substrates may have different compositions, such as different flavourants or other additives.

The electric heating arrangement 16 is thermally coupled with the base 112 of the receiving region 111. As will be described in subsequent paragraphs, in another exemplary embodiment at least part of the electric heating arrangement 16 may define the base 112 of the receiving region 111 and function to support the aerosol-generating article 20 within the receiving region.

The second housing part 120 narrows in diameter when extending from the interface 12 to an opening 121 defined at a mouthpiece end 122 of the second housing part. The mouthpiece end 122 is dimensioned to allow insertion into a user's mouth.

As shown in FIGS. 1A and 1B, two airflow channels 31a, 31b extend through the housing 11 at the interface 12 between the first and second housing parts 110, 120. For the embodiment of the aerosol-generating device 10 shown in the cross-sectional view of FIGS. 1A and 1B, the two airflow channels 31a, 31b are diametrically opposed to one another. The two airflow channels 31a, 31b are aligned to direct airflow into the mixing chamber 13 in a direction extending generally across the exposed planar surface 22 of the capsule 20 of aerosol-forming substrate. However, for the embodiment in FIGS. 1A and 1B, the airflow channels 31a, 31b are each inclined at an angle a of approximately 5 degrees relative to a plane perpendicular to the longitudinal axis, resulting in the airflow through the airflow channels also being directed slightly towards the exposed planar surface 22 of the capsule 20 of aerosol-forming substrate. A similar embodiment is also described with reference to FIGS. 4A and 4B below. It will be understood that additional airflow channels may be defined around the interface 12 between the first and second housing parts 110, 120 at circumferential locations located between the two airflow channels 31a, 31b visible in FIGS. 1A and 1B. It will also understood that the airflow channels 31a, 31b may instead be inclined to direct airflow in a direction which extends slightly away from the exposed planar surface 22 of the aerosol-forming substrate 20; such an embodiment is described with reference to FIGS. 5A and 5B.

The power source 14 is a battery. The battery may be rechargeable. For example, the battery may be a nickel cadmium battery or a lithium ion battery, which is rechargeable via an electrical connector (not shown) incorporated into the first housing part of the device. The power source 14 is coupled to the controller 15, with the controller in turn coupled to the electric heating arrangement 16. The controller 15 includes or is coupled to a memory module 15A. The memory module 15A contains instructions and data defining a thermal profile for the electric heating arrangement 16 over a usage session. The controller 15 may be activated by a user pressing a button (not shown) provided on the housing 11, the button being electrically coupled to the controller 15.

When the controller 15 is activated, the controller controls the supply of electricity from the power source 14 to the electric heating arrangement 16 in accordance with the instructions and data on the memory module 15A. More specifically, the controller 15 controls the supply of energy to the electric heating arrangement 16 to heat the aerosol-forming substrate 20 in accordance with the thermal profile. The heat imparted to the capsule 20 of aerosol-forming substrate by the electric heating arrangement 16 is sufficient to cause vapour to evolve from the exposed surface 22 of the capsule 20. A user inhaling on the mouthpiece end 122 would induce an inflow of air from outside the housing 11 through the airflow channels 31a, 31b into the mixing chamber 13. For the embodiment illustrated in FIG. 1B, the diametrically opposed airflow channels 31a, 31b are aligned to direct respective airflows therethrough towards one another within the mixing chamber 13, as well as slightly towards the exposed planar surface 22 of the capsule 20 of aerosol-forming substrate. The airflow path taken by the inflow of air through the two opposed airflow channels 31a, 31b is shown in FIG. 1B by the solid arrows. The airflows would collide with each other and mix with the heated vapour evolved from the exposed surface 22 of the capsule 20 of aerosol-forming substrate to form an entrained airflow. The collision between airflows as a consequence of the alignment of the airflow channels 31a, 31b in opposition to each other promotes turbulent airflow within the mixing chamber 13, thereby helping to facilitate thorough mixing of the airflows with the vapour evolved from the exposed surface 22 of the heated capsule 20 of aerosol-forming substrate. The suction applied by the user on the mouthpiece end 122 would draw the entrained airflow downstream through the mixing chamber 13 towards the mouthpiece end, with the entrained airflow cooling and condensing to form an aerosol before reaching the opening 121. The user would inhale the aerosol via the opening 121 in the mouthpiece end 122.

FIG. 2 shows a schematic perspective illustration of the first and second housing parts 110, 120 when separated from each other. A first set of four grooves 113a-d are defined in a first axial end 114 of the first housing part 110. A second set of four grooves 123a-d are similarly defined in a second axial end 124 of the second housing part 120. The first and second axial ends 114, 124 are shown as planar. The first and second sets of grooves 113a-d, 123a-d are defined in the respective first and second axial ends 114, 124 so that each one of the first set of grooves aligns with a corresponding one of the second set of grooves to form corresponding ones of the airflow channels 31a-d when the first and second axial ends are mated with each other in a predetermined relative alignment. For the embodiment illustrated in FIG. 2, the first and second sets of grooves 113a-d, 123a-d are uniformly spaced around the respective first and second axial ends 114, 124. A pair of electrically conductive contacts 201a, 201b are provided on the first axial end 114 of the first housing part 110. Electrical wiring 202 extends from each of the electrically conductive contacts 201a, 201b within the first housing part 110 to the controller 15 and the electric heating arrangement 16. A pair of electrically conductive contacts 203a, 203b are also provided on the second axial end 124 of the second housing part 120. Electrical wiring 204 extends within the second housing part 120 to couple to each of the electrically conductive contacts 203a, 203b. When the first and second axial ends 114, 124 are mated to each other with the first set of grooves 113a-d aligning with respective ones of the second set of grooves 213a-d, the electrically conductive contacts 201a, 203a engage with each other and electrically conductive contacts 201b, 203b similarly engage with each other. When the contacts 201a: 203a, 201b: 203b are engaged in this manner, the electrical wiring 202, 204 together defines an electrically conductive pathway between the controller 15 and the electric heating arrangement 16, permitting conveying of electric current and/or control signals from the controller 15 to the electric heating arrangement 16. When the first and second housing parts 110, 120 are uncoupled from each other, the electrically conductive pathway is interrupted, with the electrical current and/or control signals then unable to be conveyed between the controller 15 and the electrical heating arrangement 16.

FIGS. 3A and 3B shows two alternative embodiments to the embodiment of FIG. 2. In the embodiment of FIG. 3A, the first axial end 114 of the first housing part 110 is free of any grooves. In this embodiment, grooves 123a-d are only defined on the second axial end 124 of the second housing part. So, on mating of the first and second axial ends 114, 124 with each other, each of the airflow channels 31a-d is defined by one of the grooves on the second axial end of the second housing part in combination with that portion of the first axial end of the first housing part aligning with the respective groove. The embodiment of FIG. 3B represents a converse scenario to FIG. 3. More specifically, in the embodiment of FIG. 3B, the second axial end 124 of the second housing part 120 is free of any grooves, with grooves 113a-d only defined on the first axial end 114 of the first housing part 110. So, on mating of the first and second axial ends 114, 124 with each other, each of the airflow channels 31a-d is defined by one of the grooves on the first axial end of the second housing part in combination with that portion of the second axial end of the second housing part which aligns with the respective groove.

Although FIGS. 2, 3A and 3B show embodiments in which a plurality of airflow channels 31a-d are uniformly distributed around the annular interface 12 formed by the mating of the first and second axial ends 114, 124, in other embodiments the spacing between adjacent ones of the plurality of airflow channels may be non-uniform. Further, although FIGS. 2, 3A and 3B show embodiments in which each groove 113a-d, 123a-d is defined by two angled surfaces coinciding at an apex, it is to be understood that the grooves defining the interior surface of the airflow channels may take any other form. By way of example, the grooves 113a-d, 123a-d may be formed of a continuously curved surface. It will further be understood that although FIGS. 2, 3A and 3B show examples incorporating a plurality of airflow channels 31a-d formed by the mating of the first and second axial ends 114, 124, in other embodiments, only a single airflow channel 31 may be defined.

FIGS. 4A and 4B show two schematic cross-sectional illustrations of the first and second housing parts 110, 120 of the aerosol-generating device 10. FIG. 4A shows the first and second housing parts 110, 120 separated from each other. FIG. 4B shows the first and second housing parts 110, 120 coupled to each other in a predetermined relative alignment to define a pair of diametrically opposed airflow channels 31a, 31b at the interface 12 between the first axial end 114 of the first housing part 110 and the second axial end 124 of the second housing part 120. It will be understood that additional airflow channels may be present at locations around the interface 12 between the pair of opposed airflow channels 31a, 31b shown in FIG. 4B. The respective grooves 113a-b, 123a-b defined in the first and second axial ends 114, 124 are formed such that the airflow channels 31a, 31b resulting from aligning of the grooves in the first axial end with the grooves in the second axial end direct airflow into the mixing chamber 13 generally across the exposed surface 22 of the capsule 20 of aerosol-forming substrate, but also in a direction extending slightly towards the exposed surface of the capsule. This results in each airflow impinging on the exposed surface 22 of the capsule 20; each of these two airflows is shown by solid arrows in FIG. 4B. The impinging of the airflows with the exposed surface 22 of the capsule 20 may help to inhibit overheating of the aerosol-forming substrate. The airflows may also collide with each other, as discussed above for the embodiment of FIG. 1B. The airflows also mix with vapour evolved from the exposed surface 22 of the capsule 20 (this vapour is indicated by broken arrows in FIG. 4B) to form the entrained airflow previously described. In common with FIG. 1B, the inclination of the airflow channels 31a, 31b is represented by the acute angle a between the path defined by the airflow channel and a plane perpendicular to the longitudinal axis LA. Although a shallow angle a of around 5 degrees is illustrated in FIG. 4B, the airflow channels 31a, 31b may be inclined at greater angles to provide a greater amount of impingement of the airflow with the surface of the capsule of aerosol-forming substrate. For example, angle a may be as high as 45 degrees. Alternatively, the airflow channels 31a, 31b may be inclined at angles lower than 5 degrees or even aligned parallel to a plane perpendicular to the longitudinal axis LA. It will also be understood that the inclination angle a may differ between different airflow channels.

For the embodiment illustrated in FIGS. 4A, 4B, the electric heating arrangement 16 is an inductive heating arrangement. The inductive heating arrangement has an inductor 161 and a susceptor 162. The susceptor 162 is in the form of a disc of stainless steel; however, it is to be understood that the susceptor 162 may be formed of other suitable materials capable of heating via induced eddy currents and/or magnetic hysteresis. A surface of the susceptor 162 defines the base 112 of the receiving region 111. The inductor 161 is in the form of an electrically conductive coil positioned beneath the susceptor 162. The inductor 161 is supported on a thermal and magnetic shield 163. Opposite ends 1611, 1612 of the inductor coil 161 pass through holes 1631, 1632 defined in the thermal and magnetic shield 163 to couple with the controller 15, thereby facilitating the supply of energy to the inductor coil. The capsule 20 of aerosol-forming substrate is positioned on the surface of the susceptor 162. When activated, the controller 15 controls the supply of an alternating electric current from the power source 14 to the inductor coil 161, resulting in the generation of an alternating magnetic field by the inductor coil. Where the power source 14 provides a DC current, the controller 15 includes a DC/AC converter (not shown) for converting the DC current supplied from the power source to an alternating current. The susceptor 162 is positioned within the alternating magnetic field and experiences heating by one or both of eddy current heating (where the susceptor is electrically conductive) and magnetic hysteresis (where the susceptor is magnetic). Heat is predominantly transferred to the capsule 20 of aerosol-forming substrate by conduction between contacting surfaces of the susceptor 162 and the capsule 20 of aerosol-forming substrate. The heating of the capsule 20 of aerosol-forming substrate results in vapour being evolved from the exposed surface 22 of the capsule, as indicated by the broken arrows in FIG. 4B.

FIGS. 5A and 5B show a variation to the embodiment of FIGS. 4A and 4B in which the respective grooves defined in the first and second axial ends are formed such that the airflow channels 31a, 31b resulting from aligning of grooves in the first axial end 114 with grooves in the second axial end 124 direct airflow into the mixing chamber 13 generally across the exposed surface 22 of the capsule 20 of aerosol-forming substrate, but also in a direction extending slightly away from the exposed surface of the capsule of aerosol-forming substrate. The flow of incoming air in a direction slightly away from the capsule 20 of aerosol-forming substrate results in suction being developed in region A, between the path taken by the airflows through the mixing chamber 13 (represented by the solid lines in FIG. 5B) and the exposed surface 22 of the capsule 20 of aerosol-forming substrate seated in the receiving region 111. The suction or reduced pressure in region A has the effect of drawing in vapour evolved from the exposed surface 22 of the heated capsule 20 of aerosol-forming substrate (represented by the broken arrows in FIG. 5B), with the airflow and vapour mixing to form the entrained airflow previously described. In common with FIG. 4B, the inclination of the airflow channels 31a, 31b is represented by the acute angle a between the path defined by the airflow channel and a plane perpendicular to the longitudinal axis LA. Although a shallow angle a of around 5 degrees is illustrated in FIG. 5B, the airflow channels 31a, 31b may be inclined at greater angles. Alternatively, the airflow channels 31a, 31bmay be inclined at angles lower than 5 degrees or even aligned parallel to a plane perpendicular to the longitudinal axis LA. Again, it will also be understood that the inclination angle a may differ between different airflow channels.

It will be understood that in alternative embodiments to those of FIGS. 4A-B and 5A-B, the electric heating arrangement may be a resistive heating arrangement instead of an inductive heating arrangement.

FIGS. 6A and 6B show a side elevation view of first and second housing parts 110, 120 of an embodiment of the aerosol-generating device 10 in which a threaded interface is used to provide a secure coupling of the first housing part with the second housing part in a predetermined relative alignment. More specifically, the second housing part 120 is provided with an externally threaded section 126 which engages with a corresponding internally threaded section 116 of the first housing part 110. The externally threaded section 126 and internally threaded section 116 are formed such that on the first axial end 114 of the first housing part 110 mating with the second axial end 124 of the second housing part 120, the grooves 113a, b defined in the first axial end align with corresponding grooves 123a, b defined in the second axial end to form respective ones of the airflow channels 31a, 31b. The curved arrow in FIG. 6B shows the direction in which the second housing part 120 is turned relative to the first housing part 110 in order to screw the two housing parts together. It will be understood that in another embodiment (not shown), a bayonet or other form of mechanical connection may be used to securely couple the first and second housing parts 110, 120 to each other.

FIG. 7 shows an embodiment in which the first housing part 110 includes an ejector assembly. The ejector assembly has an ejector 41, a spring 42 and a cup-shaped member 43. The ejector 41 and spring 42 are mounted inside the cup-shaped member 43. The cup-shaped member 43 is mounted within the first housing part 110 so that a base 431 of the cup-shaped member supports a susceptor 162. The susceptor 162 defines the base 112 of the receiving region 111, providing a surface for supporting a capsule of aerosol-forming substrate (in a similar manner to the embodiments of FIGS. 4A-B and 5A-B). The ejector 41 is positioned inside the cup-shaped member 43. Inductor coil 161 is positioned between the base 431 of the cup-shaped member 43 and a planar surface of the ejector 41. The spring 42 is positioned inside the cup-shaped member 43, with opposite ends of the spring acting against an underside of the ejector 41 and an interior surface of the first housing part 110. The ejector 41 is moveable between a first position (shown in FIG. 7) in the direction of the arrows towards the first axial end 114. In the first position, the spring 42 is compressed, with the susceptor 162 positioned within the receiving region 111 for supporting a capsule of aerosol-forming substrate in the receiving region. In the second position, the compressive force in the spring 42 is released and causes the ejector 41 and the susceptor 162 to translate in the direction of the arrows outwards from the receiving region 111. Once the ejector 41 is in the second position, a user may easily extract a (used) capsule from the surface of the susceptor 162. The aerosol-generating device 10 may include a mechanical interlock to retain the ejector 41 in the first position until the interlock is release, for example, by a user actuating a button or lever on the device. In another embodiment, one or more magnets (for example, an electromagnet assembly) may be used in place of a spring to displace the ejector 41 between first and second positions. Although the embodiment of FIG. 7 employs an inductive heating assembly (formed of inductor coil 161 and susceptor 162), it will be appreciated that in other embodiments a resistive heating arrangement may be employed.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device, comprising:
a housing; and
an electric heating arrangement,
the housing extending along a longitudinal axis, the housing comprising a first housing part and a second housing part releasably couplable to each other to define a mixing chamber therein, wherein a coupling is such that a first axial end of the first housing part mates with a second axial end of the second housing part at an interface, the first housing part comprising a receiving region configured to receive an aerosol-generating article comprising an aerosol-forming substrate,
the electric heating arrangement being positioned within the housing to be in thermal communication with the receiving region,
the first and the second axial ends being shaped and configured such that, on coupling of the first housing part with the second housing part, at least one airflow channel is defined at the interface by the mated first and second axial ends, the at least one airflow channel extending through a wall of the housing into the mixing chamber to direct airflow into the mixing chamber in a direction transverse to the longitudinal axis, across the receiving region,
wherein the first axial end comprises at least one first groove and the second axial end comprises at least one second groove, and wherein the first and the second grooves are arranged to align with each other on coupling of the first housing part with the second housing part to thereby define the at least one airflow channel.

17. The aerosol-generating device according to claim 16, wherein the at least one airflow channel is arranged to direct airflow into the mixing chamber partially along the longitudinal axis and away from the receiving region.

18. The aerosol-generating device according to claim 17, wherein the at least one airflow channel is configured to direct airflow into the mixing chamber so as to provide a reduction in static pressure between the receiving region and the at least one airflow channel.

19. The aerosol-generating device according to claim 16, wherein the at least one airflow channel is arranged to direct airflow into the mixing chamber partially along the longitudinal axis and towards the receiving region.

20. The aerosol-generating device according to claim 16, wherein the at least one airflow channel comprises a plurality of airflow channels, the plurality of airflow channels defined at the interface by the mated first and second axial ends, different ones of the plurality of airflow channels arranged in opposition to each other so as to direct respective airflows towards each other within the mixing chamber.

21. The aerosol-generating device according to claim 16,
wherein the at least one airflow channel comprises a plurality of airflow channels,
wherein the first axial end comprises a first group of grooves and the second axial end comprises a second group of grooves, and
wherein the first and the second groups of grooves are arranged such that, on coupling of the first housing part with the second housing part, each groove of the first group of grooves aligns with a corresponding groove of the second group of grooves to define a pair of aligned grooves, each pair of aligned grooves defining a corresponding one of the plurality of airflow channels.

22. The aerosol-generating device according to claim 16, wherein one of the first axial end and the second axial end comprises at least one groove, the at least one groove defining the at least one airflow channel on coupling of the first housing part with the second housing part, the other of the first and the second axial ends being groove-free at least at a location of alignment with the groove.

23. The aerosol-generating device according to claim 22, wherein the at least one airflow channel is aligned parallel to a plane normal to the longitudinal axis.

24. The aerosol-generating device according to claim 16, wherein the interface is an annular interface, the first and the second axial ends being shaped and configured such that, on coupling of the first housing part with the second housing part, a plurality of the airflow channels is defined at the interface by the mated first and second ends, the plurality of airflow channels being distributed around the annular interface.

25. The aerosol-generating device according to claim 16,
further comprising a power supply and control electronics, the control electronics being configured to control a supply of energy from the power supply to the electric heating arrangement,
wherein coupling of the first housing part to the second housing part defines an electrically conductive pathway between the power supply and the electric heating arrangement, and
wherein uncoupling of the first housing part from the second housing part breaks the electrically conductive pathway.

26. The aerosol-generating device according to claim 16,
wherein the first and the second housing parts are tubular,
wherein an interior wall of the tubular first housing part defines a periphery of the receiving region, the receiving region being configured to receive a disc-shaped aerosol-generating article.

27. The aerosol-generating device according to claim 16, wherein a planar surface of the electric heating arrangement defines a base of the receiving region.

28. The aerosol-generating device according to claim 27, wherein the planar surface forms part of one of a resistive heating element or a susceptor of the electric heating arrangement.

29. The aerosol-generating device according to claim 16, further comprising an ejector assembly configured to urge the aerosol-generating article out from the receiving region of the first housing part.

30. An aerosol-delivery system comprising the aerosol-generating device according to claim 16 and an aerosol-generating article comprising an aerosol-forming substrate, the aerosol-generating article being arranged in the receiving region, the at least one airflow channel extending through the wall of the housing into the mixing chamber to direct airflow into the mixing chamber in a direction transverse to the longitudinal axis, across a surface of the aerosol-generating article.

31. The aerosol-delivery system according to claim 30, wherein the aerosol-generating article comprises opposed planar surfaces connected by one or more peripheral edge surfaces, in which the opposed planar surfaces define a major portion of a total external surface area of the aerosol-generating article relative to the one or more peripheral edge surfaces.
